(19) United States
(12) Patent Application Publication
(10) Pub. No.: US 2015/0289475 A1
(43) Pub. Date: Oct. 15, 2015

(54) Pet Spa Chair

(71) Applicants: Tom Stevenson, Metuchen, NJ (US); Jingmei Liu, Metuchen, NJ (US)

(72) Inventors: Tom Stevenson, Metuchen, NJ (US); Jingmei Liu, Metuchen, NJ (US)

(21) Appl. No.: 14/251,209

(22) Filed: Apr. 11, 2014

(51) Int. Cl. A01K 1/06; A01K 13/00

(52) U.S. Cl. CPC A01K 1/0613; A01K 13/00

(57) ABSTRACT

A pet spa chair with a platform and carriage base supporting a removable and adjustable ergonomically shaped carriage sized to support a pet from its underbody; with the carriage frame continuing and extending upward as to receive the pet's posterior and allowing for comfortable restful placement of the pet's tail on one end; with a handle continuing and extending upward whereby forming a handle on that same end; with a conical collar on the other end placed to receive the pet's head, protect the pet's ears and eyes from water and solutions, while limiting the pet's movement and protecting the individual handler; with a handle continuing and extending upward whereby forming a handle on that same end; and with restraints attached to the frame for the purpose of securing the pet's legs.

### CROSS-REFERENCE TO RELATED APPLICATIONS

U.S. Pat. No. 6,553,943, B1

U.S. Pat. No. 5,632,231

U.S. Pat. No. 5,974,601

### BACKGROUND OF THE INVENTION

1. Field of Invention

The present invention relates generally to an apparatus for bathing or grooming a pet either indoors or outdoors. The invention provides an individual with great flexibility and many options of how to be best able to bath and/or groom a pet.

2. Discussion of Related Art

Household pets, such as dogs and cats, often require bathing and grooming. There have been no designs or devices which allow for the safe and secure placement and restraint of a pet in a device contemplated for the use and purpose of grooming, bathing, and nail clipping, and cleaning of the pet which also provides protection to the pet's ears, eyes, and face while also protecting the individual handler and facilitator of the device and also allowing for ease of use and manipulation of the carriage on different angles and axis.

### SUMMARY OF THE INVENTION

The invention contemplates a removable and adjustable carriage with supporting carriage base and platform to be employed for the grooming, bathing, and nail clipping, and cleaning of the pet. The base frame provides for a three hundred and sixty degree rotation (360°) of the pet spa chair. The carriage consists of a frame ergonomically shaped with ribs connecting the frame at the bottom and creating the carriage to hold the pet.

A pet spa chair with a platform base supporting a pivoted carriage base upon which rests removable and adjustable carriage sized to support a pet from its underbody; with the carriage frame continuing and extending upward as to receive the pet's posterior and allowing for comfortable restful placement of the pet's tail on one end; with a handle continuing and extending upward whereby forming a handle on that same end; with a conical collar on the other end placed to receive the pet's head, protect the pet's ears and eyes from water and solutions, while limiting the pet's movement and protecting the individual handler; with the carriage frame continuing and extending upward whereby forming a handle on that same end; and with restraints attached to the frame for the purpose of securing the pet's legs.

### DRAWINGS

### (A) Figures

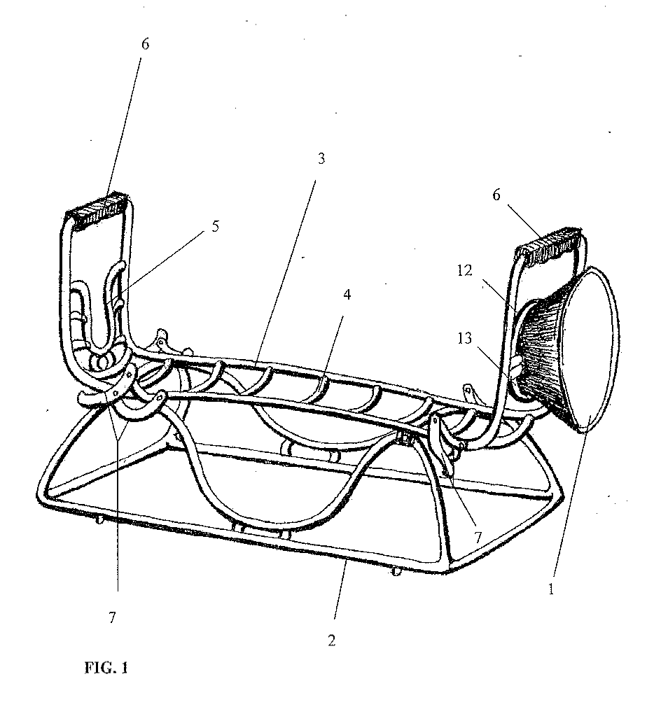

FIG. 1 is a three-dimensional view of a pet spa chair.

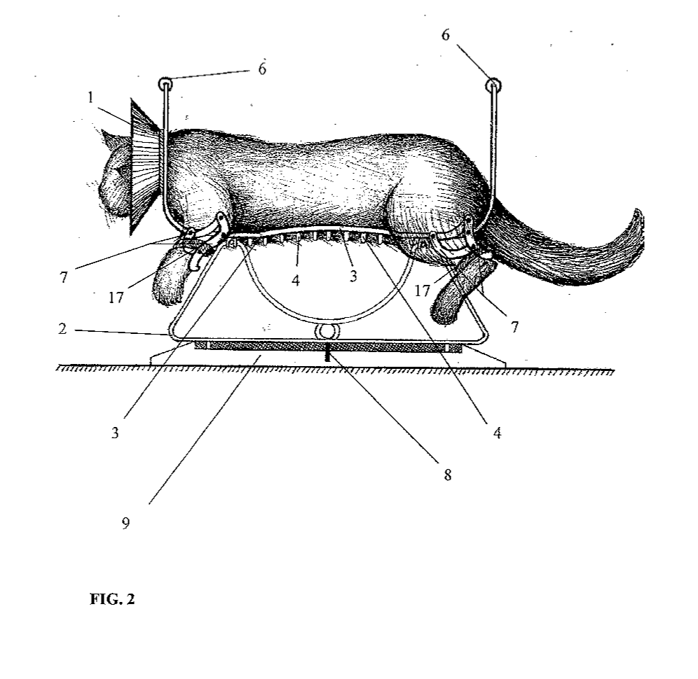

FIG. 2 is a two-dimensional side view of a pet spa chair with a pet situated and placed into the apparatus as to provide example of proper use.

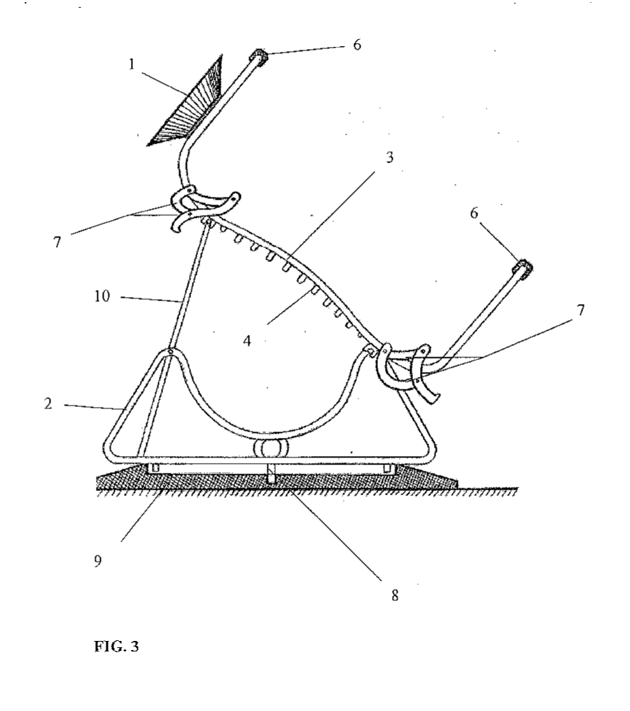

FIG. 3 is a two-dimensional side view of pet spa chair with a pole which may be attached and connected to separate predetermined points on the carriage frame, which permits the carriage frame to be raised and lifted, changing the height and angle of the carriage.

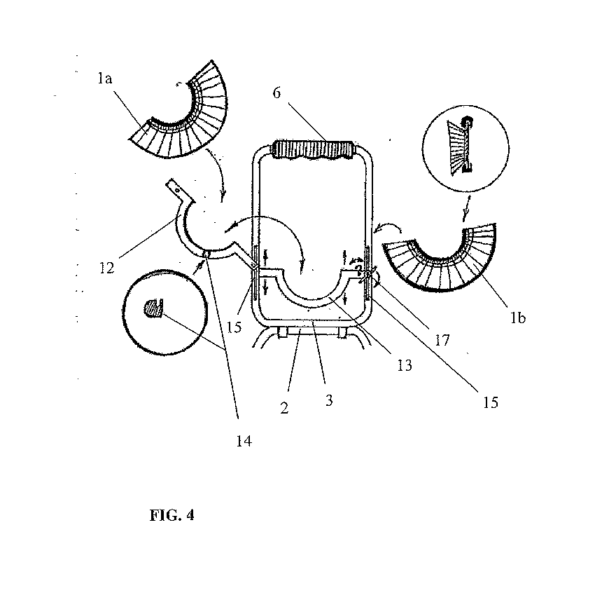

FIG. 4 is a two-dimensional frontal view of the conical collar end of the upper half of the apparatus exemplifying an envisioned embodiment of a design for the adjustable conical collar clamp holders.

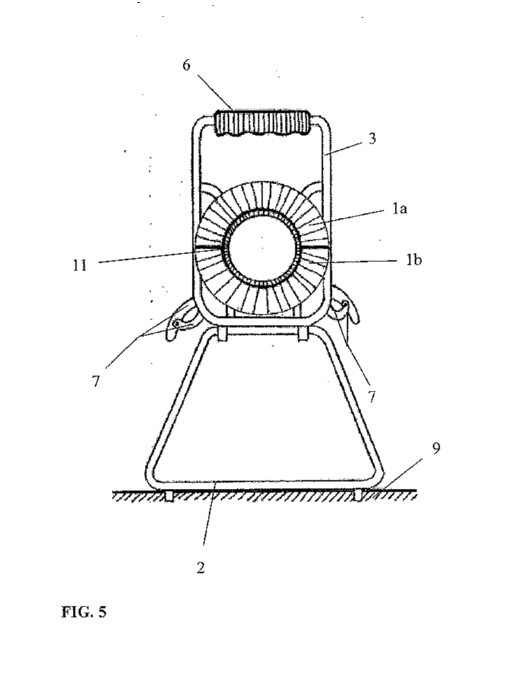

FIG. 5 is a two-dimensional frontal view of the conical collar end of the of the pet spa chair.

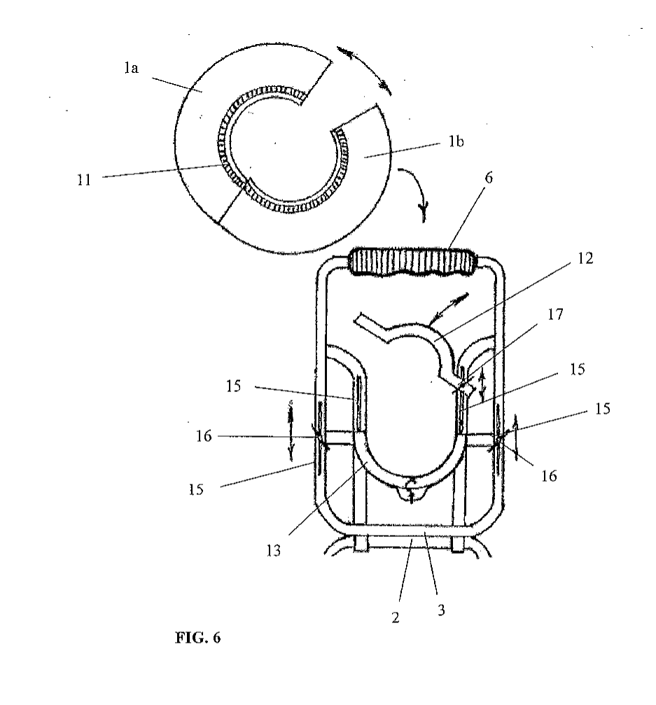

FIG. 6 is a two-dimensional frontal view of the conical collar end of the upper half of the apparatus exemplifying an alternate envisioned embodiment of a design for the adjustable conical collar clamp holders.

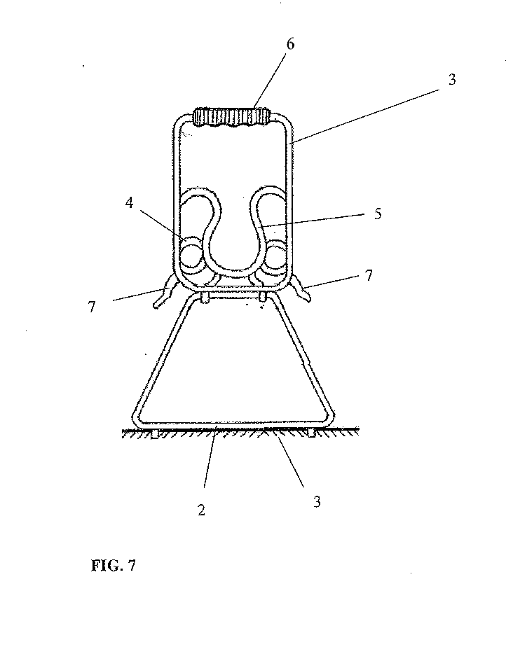

FIG. 7 is a two-dimensional frontal view of the posterior end of the of the spa chair .

### (B) REFERENCE NUMERALS

1 conical collar
1a upper half of conical collar
1b lower half of conical collar
2 carriage base frame
3 carriage frame
4 carriage rib
5 posterior/tail rest
6 carriage handle
7 paw/leg restraint
8 carriage base frame pivot
9 platform base
10 adjustable pole
11 inner collar rim belly
12 upper half of collar clamp
13 lower half of collar clamp
14 channel within reference numerals 12 and 13
15 channel for adjustment of height of collar clamps
16 wingnut

### DETAILED DESCRIPTION

The pet spa chair apparatus as shown in FIG. 1 includes a carriage base 2 supporting a removable and adjustable ergonomically shaped carriage frame 3 and connecting carriage ribs 4 thus creating the supporting carriage. The carriage frame 3 continues and extends upwards whereby forming a handles 6 and with leg/paw restraints 7 strategically positioned and attached to the carriage frame so as to secure the pet's legs to the apparatus. On one end of the apparatus is a conical collar 1 attached to the carriage frame 3 by an upper collar clamp 12 and a lower collar clamp 13 at a position directly below the handle 6. On the other end of the apparatus is an ergonomically shaped posterior/tail rest 5 allowing for support and comfort of the pet as continuing and extending up from the carriage frame 3 and connected to the carriage frame 3 by carriage ribs 4 and by its own accord under directly below the handle 6.

As seen in FIG. 2, the pet spa chair apparatus may, from the carriage base frame 2, rest upon a platform base 9. The apparatus may include a pivot 8 connecting the carriage base frame 2 to the platform base 9.

As seen in FIG. 3, the pet spa chair apparatus may include an adjustable pole 10 which may be attached to the carriage base frame 2 and then to predetermined points allowing for adjustment to the height and angle of the ergonomically shaped carriage frame 3.

As seen in FIG. 4, the conical collar 1 may consist of two separate pieces 1a & 1b, wherein 1a is an upper half of the conical collar and 1b is the lower half of the conical collar or as may be a whole singular piece 1. The conical collar 1 is secured to the apparatus by an upper half collar clamp 12 and a lower half collar clamp 13. The upper half collar clamp 12 and the lower half collar clamp 13 are adjustable vertically in positioning along channels 15 in the carriage frame 3 and secured in place by a wingnut 17. The upper half collar clamp 12 and the lower half collar clamp 13 each contain a channel 14 (as depicted per the cross-section) in which the conical collar 1—which may consist of two separate pieces 1a & 1b, wherein 1a is an upper half of the conical collar and 1b is the lower half of the conical collar or as may be a whole singular piece 1—rests and is held in place.

As seen in FIG. 5, the conical collar 1 which may consist of two separate pieces 1a & 1b, wherein 1a is an upper half of the conical collar and 1b is the lower half of the conical collar or as may be a whole singular piece 1, as shown from the front, with an inner collar rim belly 11.

An alternative envisioned embodiment as seen in FIG. 6, of the conical collar 1 which may consist of two separate pieces 1a & 1b, wherein 1a is an upper half of the conical collar and 1b is the lower half of the conical collar or as may be a whole singular piece 1 and the inner collar rim belly 11 as may be secured to the carriage frame 3.

As seen in FIG. 7, the apparatus as viewed from the back end providing a view of the ergonomically shaped posterior/tail rest 5 as connected to the carriage frame 3 by the carriage ribs 4.

1. An apparatus for grooming and bathing a pet comprising:
an ergonomically shaped carriage frame sized to support a pet from its underbody;
a carriage frame continuing and extending upward as to receive the pet's posterior and allowing for comfortable restful placement of the pet's tail on one end;
a carriage frame continuing and extending upward forming handles on each end which permits a person to easily move the apparatus with the pet in place;
a conical collar placed to receive a pet's head, protect a pet's ears and eyes, limit a pet's movement, and protect the individual handler;
a carriage frame with mounted restraints and straps which allow for a pet's legs to be restrained and suspended in the apparatus.

2. The apparatus as recited in claim 1 consisting of an optional pole, of a defined or expandable length, which attaches to the supporting carriage base and connects to separate predetermined points on the carriage frame, which permits the carriage frame to be raised and lifted, changing the height and angle of the carriage.

3. The apparatus as recited in claim 1 wherein said conical collar is adjustable to better fit the pet's head and neck for increased comfort and protection.

4. The apparatus as recited in claim 1 wherein said carriage frame is set upon an optional carriage platform base and thereupon is turnable on a pivot attached to the carriage frame and platform base.

5. The apparatus as recited in claim 1 wherein said handles permit a person to raise and lower the apparatus with the pet in place when using the optional pole of claim 2.
